(19) United States
(12) Patent Application Publication
(10) Pub. No.: US 2025/0068251 A1
(43) Pub. Date: Feb. 27, 2025

(54) Method For a Gesture Recognition System for Improving Gesture Recognition, Device, Computer Program and Vehicle

(71) Applicant: Bayerische Motoren Werke Aktiengesellschaft, Muenchen (DE)

(72) Inventors: Thomas Frommann, Seefeld (DE); Stefan Heijboer, Mountain View, CA (US)

(21) Appl. No.: 18/724,163

(22) PCT Filed: Nov. 25, 2022
(86) PCT No.: PCT/EP2022/083232

§ 371 Date: Jun. 25, 2024

(30) Foreign Application Priority Data
Jan. 10, 2022 (DE) 10 2022 100 332.9

(51) Int. Cl. G06F 3/01; B60K 35/10; G01S 13/62

(52) U.S. Cl. CPC G06F 3/017; B60K 35/10; G01S 13/62; G06F 3/013; B60K 2360/1464; B60K 2360/149

(57) ABSTRACT

A method for a gesture recognition system improves gesture recognition. The gesture recognition system has at least a first sensor and a second sensor. The method includes determining a user gesture by means of the first sensor, and determining a user's intention to act using the second sensor in order to improve the determination of the user gesture. The method further includes determining a user input based on the determined user gesture and the determined intention to act. The method also includes carrying out an operation based on the user input.

The present application is the U.S. national phase of PCT Application PCT/EP2022/083232 filed on Nov. 25, 2022, which claims priority of German patent application No. 10 2021 100 332.9 filed on Jan. 10, 2022, the entire contents of which are incorporated herein by reference.

### TECHNICAL FIELD

This disclosure relates generally to gesture recognition, and devices, systems and methods for improving gesture recognition.

### BACKGROUND

Gesture recognition systems based on direction of view recognition or radar sensors are known from other systems. Both systems have in common that reliable recognition of gestures only works to a limited extent. In particular, both systems are susceptible to false positives.

There is therefore a need to provide a concept for a gesture recognition system for improving gesture recognition.

### SUMMARY

The above-stated need is addressed by methods, devices and vehicles disclosed and claimed herein.

At least some exemplary embodiments are based on the core idea that gesture recognition of a gesture recognition system can be improved by determining a user gesture and a user's intention to act in order to determine an (intended) user input. The combination of the determined user gesture with the determined user's intention to act can serve to minimize false recognitions, for example by checking whether the user's intention to act is consistent with the user gesture.

Exemplary embodiments concern a method for a gesture recognition system for improving gesture recognition, wherein the gesture recognition system contains a first sensor and a second sensor. The method includes determining a user gesture using the first sensor and determining a user's intention to act using the second sensor for improving the determination of the user gesture. Furthermore, the method includes determining a user input on the basis of the determined user gesture and the determined intention to act and carrying out the user input. This can improve gesture recognition by comparing the determined user gesture with a user's intention to act, in particular false recognitions can be avoided.

With some exemplary embodiments, the determination of the user gesture may include determination by means of the first sensor in the radar range. This can improve the accuracy of determination of a user gesture, especially a micro-user gesture.

With some exemplary embodiments, the determination of a user's intention to act may include determining a user's direction of view by means of the second sensor. This makes it possible to determine the user's intention to act in a particularly suitable way.

With some exemplary embodiments, the user gesture may include a micro-user gesture. As a result, a user can create a user gesture by means of very small movements, for example by means of a hand, which can improve a user experience.

With some exemplary embodiments, the determined user's intention to act can be used to determine a plurality of user inputs based on a plurality of determined user gestures within a predefined time. This can reduce the energy requirement for the use of the second sensor, as it is not necessary, for example, to permanently evaluate sensor data and/or operate the second sensor.

With some exemplary embodiments, the user input can only be carried out if the determined user gesture and the determined intention to act are consistent. In particular, this can prevent false recognitions, which can improve a user experience.

Exemplary embodiments also provide a computer program for carrying out the method described herein when the computer program runs on a computer, a processor, or a programmable hardware component.

Another exemplary embodiment is a device for a gesture recognition system for improving gesture recognition. The device contains one or more interfaces for communication with other communication devices (for example the first sensor, the second sensor, etc.) and a control module designed to carry out at least one of the methods described herein.

Exemplary embodiments also provide a vehicle with a gesture recognition system such as described herein. can contain a display, Optionally, the vehicle especially a non-touch-sensitive display, wherein the control module can be designed to use the user input to change content shown on the display. This can enhance a user experience when operating the display by means of gesture control.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of a method for a gesture recognition system for improving gesture recognition;

FIG. 2 shows a block diagram of an exemplary embodiment of a device for a gesture recognition system; and

FIG. 3 shows a schematic representation of a vehicle that contains a gesture recognition system with a device of FIG. 2 for improving gesture recognition.

### DETAILED DESCRIPTION

Various exemplary embodiments are now described in more detail with reference to the enclosed drawings, in which some exemplary embodiments are shown. In the figures, the thickness dimensions of lines, layers and/or regions may be exaggerated for the sake of clarity.

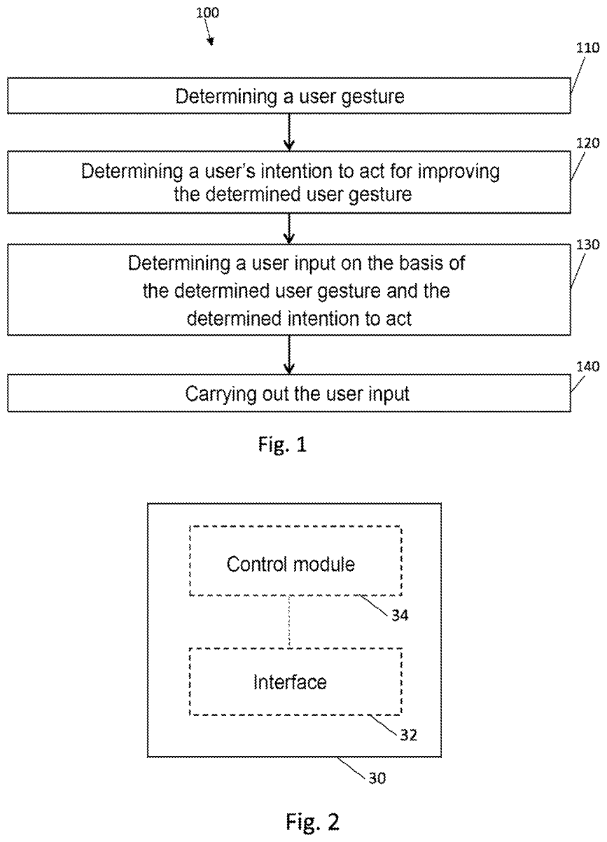

FIG. 1 shows a schematic representation of a method 100 for a gesture recognition system for improving gesture recognition, wherein the gesture recognition system contains a first sensor and a second sensor. The method 100 includes determining a 110 user gesture and determining 120 a user's intention to act for improving determination 110 of the user gesture. Furthermore, the method 100 includes determining 130 a user input on the basis of the determined user gesture and the determined intention to act and carrying out 140 the user input.

Determining 110 the user gesture by means of the first sensor can be carried out with any suitable sensor. For example, the user gesture can be determined by means of a sensor in the infrared range, in the visible range, in the radar range, etc. In particular, a user gesture can be any movement of a user, for example of a user's hand, a user's head, etc., which is intended to control an electronic device, for example a display of an electronic device. For example, each user gesture can be associated with a user input. User gestures which can be carried out by a user to control an electronic device may in particular be stored in a memory unit. The memory unit can be, for example, a part of the electronic device or a part of a central control unit (for example, a central control unit of a vehicle).

Determining 120 the intention to act of a user can be carried out with any suitable sensor. For example, the intention to act can be determined by means of a sensor in the infrared range, in the visible range, in the radar range, by means of a sound transducer, etc. The user's intention to act can be determined in particular by whether the user wanted to take an action or not. For example, a user can carry out a user gesture associated with a user input without realizing it, but show no intention to act, for example turning the head towards an object that is affected by the user input. Accordingly, a determined user gesture can be discarded/not processed further. In this case, in particular, no user input is determined 130. For example, as long as no intention to act could be determined, determination of a user input can be suspended. This minimizes or prevents false recognitions of gesture control.

For example, the minimum duration of a user's action may be required for the determination 120 of the user's intention to act. For example, a minimum time can be defined for which a user must carry out a user action. A user action can be, for example, eye contact of the user with a display. For example, an intention to act may only be recognized if a user has viewed the display for longer than the defined minimum time.

For example, a user can look at a display of an electronic device when carrying out a user gesture. Thus, when determining 120 the intention to act, it can be checked whether the user has directed his head and/or eyes towards the display of the electronic device. This can be done, for example, by means of a camera system (for example in the infrared range or visible range). If a user does not have any intention to act when carrying out the user gesture, such as turning the head and/or looking towards an electronic device that is to be operated by the user gesture, the user gesture can be discarded.

For example, a user can carry out a user gesture for which determining a user input can be improved by the user's intention to act. For example, the user can watch a video on a display and carry out a user gesture that enables fast-forwarding of the video. Furthermore, the user can make an acoustic remark, for example a number that stands for a fast-forward speed. This allows a user experience to be improved because it can be possible to determine 130 a user input from the combination of the user gesture and the user's intention to act.

Determine 130 a user input can be carried out for example by a control module, for example by a central control unit of a vehicle. By combining the user gesture and the intention to act, determination 130 of the user input can be improved in terms of accuracy on the one hand and in terms of avoiding false recognitions on the other hand.

The combination of both information items (the user gesture and the intention to act by the various sensors, which in particular include different technologies) can be used in particular to prevent false recognitions, especially in the vicinity of a vehicle, for example in an interior of the vehicle. In particular, this allows a display of an electronic device that is not touch sensitive to be controlled.

For example, the user input can be carried out 140 by a control module, for example by a central control unit of a vehicle.

In one exemplary embodiment, determining 110 the user gesture may include determining 110 by means of a first sensor in the radar range. By using a first sensor in the radar range, the accuracy of the determination of the user gesture can be improved, for example compared to a sensor that works in the visible range. For example, the first sensor can operate in a frequency range of 40 GHz to 80 GHz, or from 50 GHz to 70 GHz or from 55 GHz to 65 GHz or at about 60 GHz. This frequency range/frequency allows a more reliable determination of the user gesture, especially of micro-user gestures.

In one exemplary embodiment, determining 120 a user's intention to act can include determining a user's direction of view using the second sensor. The direction of view can be determined, for example, by means of a camera that works in the visible range. Based on the direction of view, a user's intention to act can be determined with increased accuracy. For example, information can be shown on a display for which a large number of user inputs is possible by means of a user gesture, for example a tile-like representation of various files. A user can carry out a user gesture, which is determined 110 and which is used to open one of these different files. By determining the direction of view, for example compared to the determination of a head orientation, a file to be opened can be determined more precisely. On the basis of the user input, which indicates the opening of a file, for example, and a direction of view, which indicates the selected file, for example, a user input can be determined by the combination of both information items. This makes it possible to improve display of an electronic device, which can improve a user experience.

With one exemplary embodiment, the user gesture can include a micro-user gesture, in particular, the user gesture can be a micro-user gesture. A micro-user gesture can be carried out with a smaller range of motion by the user compared to a user gesture. For example, a user gesture as described above can be any movement of a user, such as of a user's hand. A micro-user gesture can then be, for example, a movement of individual fingers of a user's hand. For example, a user gesture can include a minimal lateral extension which must be achieved by the user, for example, with the fingers or the head so that the user's movement can be determined 110 as a user gesture. This lateral extension can be smaller for a micro-user gesture than for a user gesture. For example, a user gesture can involve a finger moving at least 5 cm along a lateral axis, whereas a micro-user gesture can also be a movement of less than 5 cm.

A micro-user gesture can be determined particularly suitably by means of a sensor in the radar range, since due to the reduced movements of a user when carrying out a micro-user gesture, detection with a camera system in the visible range, for example, can be more error prone.

With one exemplary embodiment, the determined user's intention to act can be used for the determination of a plurality user inputs based on a plurality of determined user gestures within a predefined time. This can reduce the energy consumption of the second sensor, in particular the evaluation of data from the second sensor and/or operation of the second sensor may only take place intermittently.

For example, a user's head orientation and/or a direction of view can be detected, which represents a user's intention to act. This intention to act can include, for example, a desired operation of a display or a change in information displayed on a display of an electronic device. After determining 120 the intention to act, this intention to act can be used to determine 130 the user input, for example, for a predefined time (for example, 1 s, 5 s, 10 s). In particular, each determined 110 user gesture can be checked to determine whether a user input should be carried out with reference to the display by the user gesture. For example, the intention to act can be used until a user gesture is not consistent with the intention to act, for example because a user gesture is not suitable for changing information shown on a display.

For example, a determined intention to act can be used until a user gesture allows a large number of user inputs. In this case, a new user's intention to act can be determined in order to determine 130 a user input from the combination of the new intention to act and the user gesture.

With one exemplary embodiment, the user input can only be carried out if the determined user gesture and the determined intention to act are consistent. In particular, this can ensure that false recognition is avoided. Furthermore, a user experience can be improved.

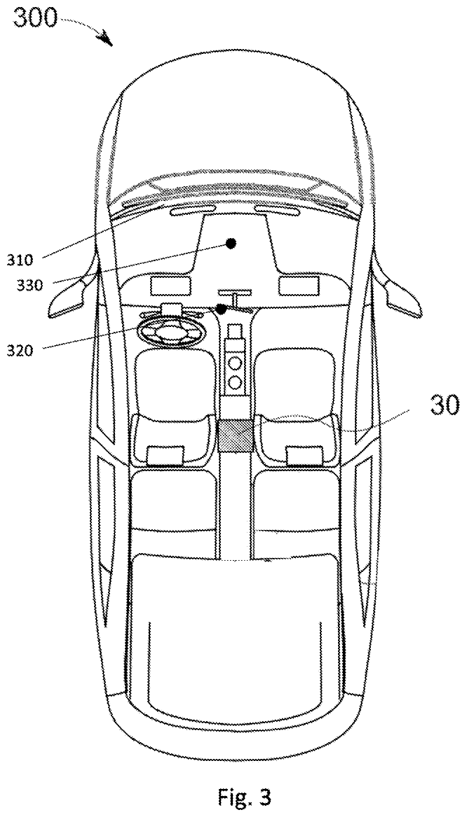

Further details and aspects are mentioned in connection with the exemplary embodiments described below. The exemplary embodiment shown in FIG. 1 may include one or more optional additional features corresponding to one or more aspects mentioned in connection with the proposed concept or one or more exemplary embodiments described below (for example FIGS. 2-3).

FIG. 2 shows a block diagram of an exemplary embodiment of a device 30 for a gesture recognition system. The device 30 for improving the performance of a gesture recognition system contains one or more interfaces 32 for communication with other components of the gesture recognition system, for example an RGB camera, a radar device, etc. The device 30 also contains a control module 34 that is designed to carry out at least one of the methods described herein, for example the method described with reference to FIG. 1. Other exemplary embodiments are a vehicle with a gesture recognition system with a device 30.

For example, the one or more interfaces 32 may correspond to one or more inputs and/or one or more outputs for receiving and/or transmitting information, for example in digital bit values, based on a code, within a module, between modules, or between modules of different entities. The at least one interface 32 can be designed, for example, to communicate with other network components via a (radio) network or a local connection network.

With exemplary embodiments, the control module 34 can correspond to any controller or processor or a programmable hardware component. For example, the control module 34 can also be implemented as software that can be programmed for a corresponding hardware component. In this respect, the control module 34 can be implemented as programmable hardware with appropriately adapted software. Any processors, such as digital signal processors (DSPs), can be used here. Exemplary embodiments are not limited to a certain type of processor. Any processors or even multiple processors are conceivable for the implementation of the control module 34.

Further details and aspects are mentioned in connection with the exemplary embodiments described below and/or above. The exemplary embodiment shown in FIG. 2 may include or one more optional additional features corresponding to one or more aspects mentioned in connection with the proposed concept or one or more exemplary embodiments described above (for example FIG. 1) and/or below (for example FIG. 3).

FIG. 3 shows a schematic representation of a vehicle 300 that contains a gesture recognition system with a device 30 from FIG. 2 for improving gesture recognition. As already explained with reference to FIG. 1, false recognition is reduced or prevented by the combination of a first sensor 320 to determine a user gesture and a second sensor 330 to determine the user's intention to act, wherein the two sensors 320, 330 are based in particular on different technologies. In particular, the first sensor 320 can be a radar device that determines a user gesture. In particular, the second sensor 330 can be an RGB camera that determines a direction of view and thus an intention to act of the user.

Inside a vehicle 300, the combination of the two sensors 320, 330 can reduce driver distraction and/or can improve determining an (intended) input. In addition, the vehicle 300 may contain a non-touch-sensitive display 310 (for example, a (panoramic) head-up display 310 integrated into the windshield of the vehicle 300). By combining the information of the first sensor 320 and the second sensor 330, of the non-touch-sensitive display 310 can be carried out, especially during operation of the vehicle 300. This avoids controlling the non-touch-sensitive display 310 by means of an input device, such as a keyboard, which can reduce driver distraction and/or improve the user experience.

For example, a steering wheel button can be used to control the non-touch-sensitive display 310, but this is only accessible for certain grip positions. This can lead to the operation of the non-touch-sensitive display 310 by means of the steering wheel button being perceived by the user as uncomfortable. Furthermore, operation by means of steering wheel buttons for a passenger is questionable from a safety point of view. Likewise, buttons that can be arranged in a center console are also disadvantageous, as they can be difficult to use on the one hand and may distract a driver for an unnecessarily long time on the other hand. In particular, buttons in the front area of the vehicle 300 cannot be used or can only be used with great difficulty by passengers in the rear area. The operation of the non-touch-sensitive 310 display can be improved by the device 30 and the connected improved gesture recognition, and in particular by covering the entire interior of the vehicle (for example by means of a large number of first sensors 320 and a large number of second sensors 330) the non-touch-sensitive display 310 can be controlled by any person in the vehicle 300. Furthermore, distraction of the driver can be reduced by the reduction/prevention of false recognitions.

For example, information (such as) content displayed on the non-touch-sensitive display 310 can be controlled very conveniently by a combination of direction of view and user gesture, especially micro-user gesture. In addition, protruding button elements can be avoided.

For example, the first sensor 320 can emit radar waves and receive a reflection of the emitted radar waves. On the basis of the received radar waves, the first sensor 320, such as a radar device, can determine a user gesture by means of a location/frequency conversion (Fourier Transformation). For example, the user gesture can be carried out from resulting range-Doppler diagrams using a machine learning network to recognize previously trained micro-user gestures.

Due to the parallel determination of the direction of view by an RGB camera-based method, it can be ensured that the micro-user gesture is not carried out unintentionally and thus a false recognition and accordingly a false operation can be minimized/prevented.

For example, the first sensor 320 may be arranged in an area of a center console of the vehicle 300. This allows user gestures, in particular which can be carried out with a hand that is positioned in the middle of the vehicle 300, to be determined particularly efficiently. This allows, for instance, a driver to carry out user gestures, especially micro-user gestures, with their right hand and/or the front passenger to carry out user gestures, especially micro-user gestures, with their left hand.

For example, the second sensor 330 can be arranged on a rear view mirror of the vehicle 300. This allows the driver's intention to act to be determined particularly efficiently, for example by determination of a direction of view. In particular, the arrangement of the second sensor 330 on the rear view mirror of the vehicle 300 enables the direction of view of the driver and the front passenger to be determined.

With one exemplary embodiment, the vehicle 300 may also contain a display 310, in particular a non-touch-sensitive display 310 (for example a panoramic head-up display), wherein the control module may be designed to use the user input to modify content shown on the display. This makes it possible, for example, to simplify the operation of content, such as controlling a media playlist or an incoming call.

Simultaneous recognition of (trained) user gestures (for example by means of machine-learning trained micro-user gestures) and the direction of view of the driver and front passenger can thus be carried out by means of the first sensor 320 and the second sensor 330. For example, control of a display of a media playlist on a panoramic head-up display 310 in the area of the windshield can be carried out. Activation of the title selection can be carried out with brief eye contact between the driver and/or front passenger with the displayed playlist for a fixed minimum period of time. Scrolling through the displayed playlist can be carried out by a first micro-user gesture, such as a slight lateral hand movement by the driver or front passenger (wave micro gesture). A selection of a title for (immediate) playback can be made, for example, by a second micro-user gesture, for example a pinch micro gesture of the driver's or passenger's thumb and index finger.

Optionally, or alternatively, a selected title can be attached to the end of a current playback loop by a third micro-user gesture, for example by a double pinch micro gesture of the driver or front passenger.

In particular, the determined user's intention to act, that is to say to control the display of the media playlist, may be used for each of the micro-user gestures described. For example, the information about the determined intention to act can be used for as long as the determined micro-user gestures enable control of the media playlist. The option of micro-user gesture operation is retained, even if a driver and/or front passenger averts their gaze from the panoramic head-up display 310.

For example, the method described above can also be used for incoming calls or messages displayed on the panoramic head-up display 310. For example, incoming calls can be answered or rejected with a user gesture/micro-user gesture by a driver and/or a front passenger.

With at least some exemplary embodiments, the vehicle 300 may correspond, for example, to a land vehicle, a watercraft, an aircraft, a rail vehicle, a road vehicle, a car, a bus, a motorcycle, an off-road vehicle, a motor vehicle, or a truck.

Further details and aspects are mentioned in connection with the exemplary embodiments described above. The exemplary embodiment shown in FIG. 3 may have one or more optional additional features corresponding to one or more aspects mentioned in the context of the proposed concept or one or more exemplary embodiments described above (for example FIGS. 1-2).

Other exemplary embodiments are computer programs for carrying out one of the methods described herein when the computer program runs on a computer, a processor, or a programmable hardware component. Depending on certain implementation requirements, exemplary embodiments can be implemented in hardware or in software. The implementation can be carried out using a digital storage medium, such as a floppy disk, DVD, Blu-ray Disc, CD, ROM, PROM, EPROM, EEPROM or FLASH memory, hard disk or other magnetic or optical memory on which electronically readable control signals are stored, which can or do work together with a programmable hardware component in such a way that the respective method is carried out.

A programmable hardware component can be formed by a processor, a computer processor (CPU=Central Processing Unit), a graphics processor (GPU=Graphics Processing Unit), a computer, a computer system, an application-specific integrated circuit (ASIC), an integrated circuit (IC), a single-chip system (SOC=System on Chip), a programmable logic element or a field-programmable gate array with a microprocessor (FPGA=Field Programmable Gate Array).

The digital storage medium can therefore be machine readable or computer readable. Some exemplary embodiments therefore contain a data carrier which has electronically readable control signals capable of interacting with a programmable computer system or a programmable hardware component in such a way that one of the methods described herein is carried out. Thus, one exemplary embodiment is a data carrier (or a digital storage medium or a computer-readable medium) on which the program for carrying out one of the methods described herein is stored.

In general, exemplary embodiments may be implemented as a program, firmware, a computer program, or a computer program product with program code or as data, wherein the program code or data is effective in such a way as to carry out one of the methods when the program runs on a processor or a programmable hardware component. The program code or data can also be stored on a machine-readable medium or data carrier, for example. The program code or data may be source code, machine code, byte code, as well as other intermediate code, among other things.

The exemplary embodiments described above are merely an illustration of the principles of the present invention. It is understood that modifications and variations of the arrangements and details described herein will be evident to other experts. Therefore, it is intended that the invention merely limits the scope of protection of the following patent claims and not of the specific details presented herein on the basis of the description and the explanation of the exemplary embodiments.

### LIST OF REFERENCE SIGNS

30 Device for improving the performance of a gesture recognition system
32 Interface
34 Control module
100 Method
110 Determining a user gesture
120 Determining a user's intention to act
130 Determining a user input
140 Carrying out the user input
300 Vehicle
310 Non-touch-sensitive display
320 First sensor
330 Second sensor

1.-10. (canceled)

11. A method for a gesture recognition system for improving gesture recognition, wherein the gesture recognition system has at least a first sensor and a second sensor, the method comprising:
determining a user gesture by means of the first sensor;
determining a user's intention to act using the second sensor in order to improve the determination of the user gesture;
determining a user input based on the determined user gesture and the determined intention to act; and
carrying out an operation based on the user input.

12. The method as claimed in claim 11, wherein determining the user gesture includes determining by means of the first sensor in a radar range.

13. The method as claimed in claim 12, wherein the first sensor includes at least one of the group consisting of a radar transmitter and a radar receiver.

14. The method as claimed in claim 13, wherein the user gesture comprises a micro-gesture, wherein the micro-gesture is movement of at least one finger of a hand of a user.

15. The method as claimed in claim 13, wherein the user gesture comprises a micro-gesture, wherein the micro-gesture is movement of less than 5 centimeters.

16. The method as claimed in claim 11, wherein
determining the user's intention to act includes determining a user's direction of view using the second sensor.

17. The method as claimed in claim 16, wherein the second sensor includes a sensor supported by a rear view mirror of a vehicle.

18. The method as claimed in claim 17, wherein the user gesture includes a micro-user gesture.

19. The method as claimed in claim 11, wherein the user gesture includes a micro-user gesture.

20. The method as claimed in claim 11, wherein the determined user's intention to act is used for determination of a plurality of user inputs based on a plurality of determined user gestures within a predefined time.

21. The method as claimed in claim 11, wherein the determined user's intention to act is used until the determined user gesture and the determined user's intention to act are consistent.

22. The method as claimed in claim 11, wherein the user input is only carried out if the determined user gesture and the determined user's intention to act are consistent.

23. A non-transitory storage device storing a computer program for carrying out the method of claim 11, when the computer program runs on a computer, a processor, or a programmable hardware component.

24. A device for a gesture recognition system for improving the performance of the gesture recognition system, containing
one or more interfaces configured to communicate with other communication devices; and
a control module configured to carry out the method of claim 11.

25. A vehicle with the device for the gesture recognition system as claimed in claim 24.

26. The vehicle as claimed in claim 25, further containing
a display,
wherein the control module is designed to use the user input to change content displayed on the display.

27. The vehicle as claimed in claim 25, wherein the display is a non-touch-sensitive display.

28. The vehicle as claimed in claim 25, further comprising a rear view mirror, and wherein the second sensor is supported by the rear view mirror.
